(19) United States
(12) Patent Application Publication
(10) Pub. No.: US 2015/0176670 A1
(43) Pub. Date: Jun. 25, 2015

(54) WAVE SPRING HAVING A LINEAR CHARACTERISTIC IN SOME REGIONS

(71) Applicant: THYSSENKRUPP PRESTA AG, Eschen (LI)

(72) Inventor: Gergely László, Esslingen-Berkheim (DE)

(73) Assignee: THYSSENKRUPP PRESTA AG, Eschen (LI)

(21) Appl. No.: 14/415,537

(22) PCT Filed: Mar. 12, 2013
(86) PCT No.: PCT/EP2013/000721

§ 371 Date: Jan. 16, 2015

(30) Foreign Application Priority Data
Jul. 16, 2012 (DE) 10 2012 013 924.1

(51) Int. Cl. F16F 1/32

(52) U.S. Cl. CPC F16F 1/328

(57) ABSTRACT

The invention relates to an axially active wave spring having a closed annular body with a central x-axis, the annular body being undulated periodically over the circumference in the direction of the x-axis, in which the wave spring has a spring height in the direction of the x-axis, which spring height is different on the inner circumference of the wave spring than on the outer circumference of the wave spring.

The present invention relates to a zigzag spring having features of the precharacterizing clause of claim 1 and to a use of a zigzag spring.

Zigzag springs are generally rings made from a spring steel which are undulated periodically in the circumferential direction. Zigzag springs are used for suspension in their axial direction, for example in order to support a bearing ring in a bearing seat such that it is sprung in the axial direction. Here, the zigzag spring lies with its maxima on the two surfaces which lie opposite one another in the relieved state, for example an annular collar of a bearing seat on one side and an axial end face of a bearing outer ring on the other side. If the two components are brought closer to one another, the zigzag spring is compressed in the axial direction. In one simple embodiment of a zigzag spring which consists of a flat closed annular body with a sinusoidal undulation structure, a linear characteristic curve is generally assumed. The linear characteristic curve causes the spring force to rise proportionally with respect to the spring travel with increasing compression of the zigzag spring. In the completely compressed state, the material of the zigzag spring bears flatly against both components. Here, the force which is produced suddenly rises to a very pronounced extent, since no further spring travel is available. Springs of this type therefore do not have an end position damping action.

Other zigzag springs have a progressive characteristic curve, in which other zigzag springs the restoring force rises greatly towards the end region of the spring travel. In a suitable form, a progressive characteristic curve of this type prevents the components from experiencing a hard impact at the end of the spring travel during normal operation. Various embodiments are known from documents U.S. Pat. No. 6,758,465 B1, U.S. Pat. No. 5,803,444 and EP 1 477 701 B1.

It is also advantageous in some applications to be able to use a zigzag spring which has a linear characteristic curve at the beginning of the spring travel, which characteristic curve then merges into a progressive characteristic curve after a defined spring travel. A spring of this type which represents the generic prior art is known from German laid-open specification DE 10 2004 018 711 A1. In the circumferential direction of the annular body, the said spring has an undulation structure which is not exactly sinusoidal, but rather is flattened in a defined way in the region of the maxima. The height of the said undulation structure is the same on that circumferential side of the zigzag spring which lies on the inside in the radial direction as on the circumferential side which lies radially on the outside. Springs of this type can tend to tilt in their cross section in some installation situations. Furthermore, it is difficult in terms of manufacturing technology to achieve precisely defined characteristic curves. A recirculating ball mechanism of the generic type is known from document DE 10 2010 029 266 A1. In the said document, two spring elements are provided, of which in each case one is arranged on the end side of the bearing outer ring between the outer ring and the adjacent housing. In this way, the bearing can yield in both axial directions counter to the spring force in the case of impact loading. In the rest state when the bearing is mounted, the two spring elements which are provided on both sides of the bearing are prestressed and are situated in the progressive region of their characteristic curve in this state. The spring elements themselves have an outer radius which corresponds approximately to the outer radius of the bearing outer ring, and an inner radius which corresponds to the inner radius of the bearing outer ring. The bearing outer ring therefore completely covers the annular spring elements which can be configured as disc springs or zigzag springs.

It is decisive for the provided function of the sprung mounting in the said document that the bearing is seated centrally between the two annular faces in the described rest state, which has the housing as an abutment for the spring elements. The provided spring travel in mountings of this type is relatively low. It lies at in each case approximately 0.1 mm on both sides of the bearing. It is a problem in the said mounting that slight tolerances of the spring elements lead to the bearing being mounted eccentrically between the bearing faces of the housing in the rest state. This so-called decentring of the bearing can be to such an extent that one of the spring elements is already compressed completely or virtually completely in the rest state and, as a consequence, the structurally provided spring travel of the bearing is not available on this side.

It is therefore an object of the present invention to provide a zigzag spring, in which there is a greater structural freedom during the stipulation of the characteristic curve. This object is achieved by a zigzag spring having the features of claim 1 and by the use of a zigzag spring having the features of claim 16.

Because the spring height is different on the inner diameter of the zigzag spring from on the outer diameter of the zigzag spring in the case of an axially active zigzag spring having a closed annular body with a central x-axis, which annular body is undulated periodically over the circumference in the direction of the x-axis, different regions with different characteristic curves can be defined simply via the available spring travel. The contact points or contact lines between the sprung surfaces and the zigzag spring itself can then migrate during the compression of the spring from a punctiform contact in the region of the greatest spring height radially to the inside or radially to the outside, and the characteristic curve can be set via the ratio of the spring heights on the inner diameter and the outer diameter, which results here in at least one free parameter which was not available in the prior art.

The spring height on the inner diameter of the annular body of the zigzag spring is preferably greater than the spring height on the outer diameter of the annular body. The spring height on the outer diameter of the annular body can be from 20% to 80% of the spring height which is present on the inner diameter, preferably from 40% to 60%. In another exemplary embodiment, the spring height on the outer diameter can be between 10% and 30% of the spring height on the inner diameter. It is provided in one special embodiment that the spring height on the outer diameter is more than 25% of the spring height on the inner diameter. It can be provided, in particular, that the spring height on the outer diameter of the annular body is equal to zero, that is to say the zigzag spring is flat there. The abovementioned values also apply in the case of a reversal of the spring heights. Thus, in another preferred embodiment, the spring height on the outer diameter of the annular body of the zigzag spring can be greater than the spring height on the inner diameter of the annular body.

The spring height on the inner diameter of the annular body can be from 20% to 80% of the spring height which is present on the outer diameter, preferably from 40% to 60%. In another exemplary embodiment, the spring height on the inner diameter can be between 10% and 30% of the spring height on the outer diameter. It is provided in one special embodiment that the spring height on the inner diameter is more than 25% of the spring height on the outer diameter. It can be provided, in particular, that the spring height on the inner diameter of the annular body is equal to zero, that is to say the zigzag spring is flat there.

In the case of a zigzag spring, the spring height of which is lower on the inner circumference than on the outer circumference, the result in terms of the technical function is a somewhat different behaviour under loading. The internal stresses in the spring material are reduced in comparison with the embodiment which was first described, which leads to an extension of the service life.

One preferred use of a zigzag spring according to the invention is the axial suspension of an anti-friction bearing of a ball nut in a spindle drive, preferably in an electromechanical motor vehicle steering system. Here, the axial suspension preferably takes place on both sides of the bearing outer ring.

Zigzag springs with a number of undulations between four and eight undulations have been used as one particularly advantageous refinement. However, an application with any other desired number can also be realized.

Because the annular, metallic zigzag springs have a linear characteristic curve at the beginning of the spring travel and a progressive characteristic curve towards the end of the spring travel if the zigzag springs are used for mounting a bearing ring in a spindle drive, a characteristic curve profile is achieved, in which tolerances of the two spring elements which are used are compensated for, such as tolerances in the spring constant or tolerances in the internal height of the spring elements in the relieved state, for example. It is shown that the advantageous effect is particularly useful in the suspension of a bearing outer ring of an anti-friction bearing for mounting a ball nut in a steering housing. Here, in each case one zigzag spring is preferably used on both sides of the bearing outer ring.

In the following text, one exemplary embodiment of the present invention will be described in greater detail using the drawing, in which:

FIG. 1 shows a zigzag spring according to the prior art in order to define the geometric variables,

FIG. 2 shows a zigzag spring according to the invention in a side view,

FIG. 3 shows the zigzag spring from FIG. 2 in an installation situation between two thrust washers, on the left-hand side in a first cross section and on the right-hand side in a cross section which is positioned turned by 30°,

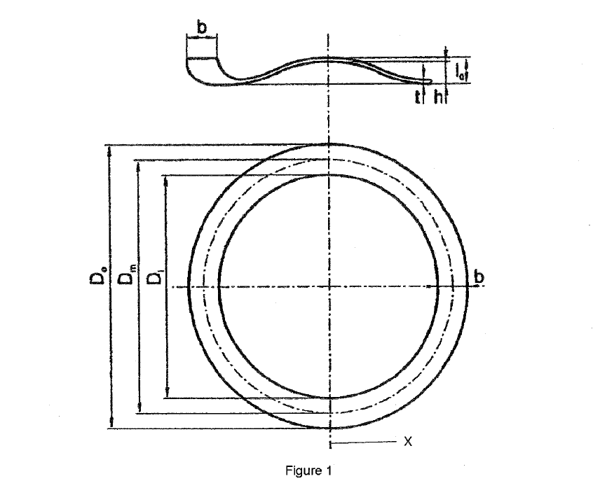

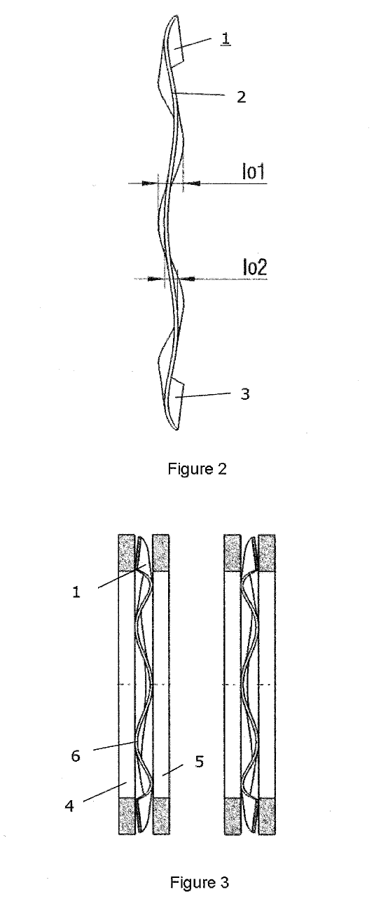

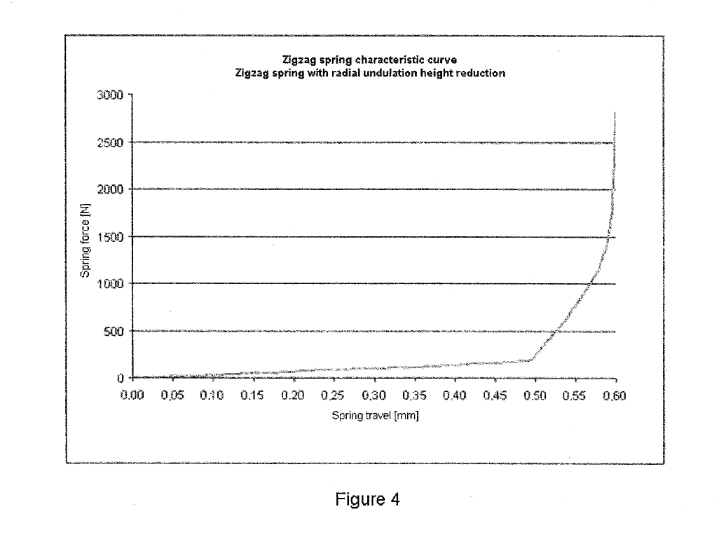

FIG. 4 shows the characteristic curve of the zigzag spring from FIG. 2,

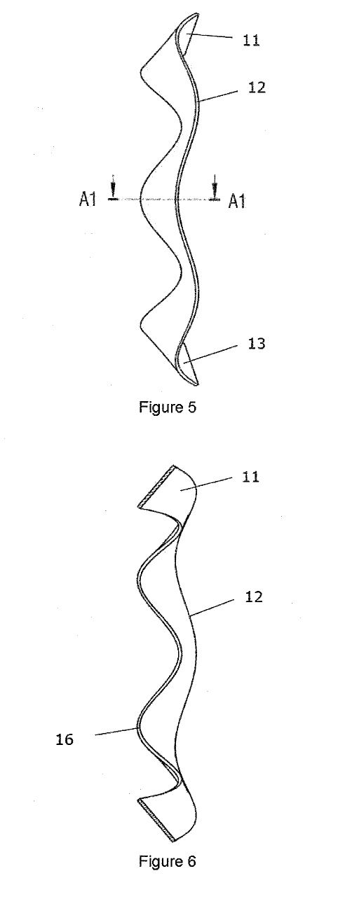

FIG. 5 shows a zigzag spring with a conical main body for use in conical seat faces, in a side view,

FIG. 6 shows the zigzag spring from FIG. 5 in a cross section from the side, and

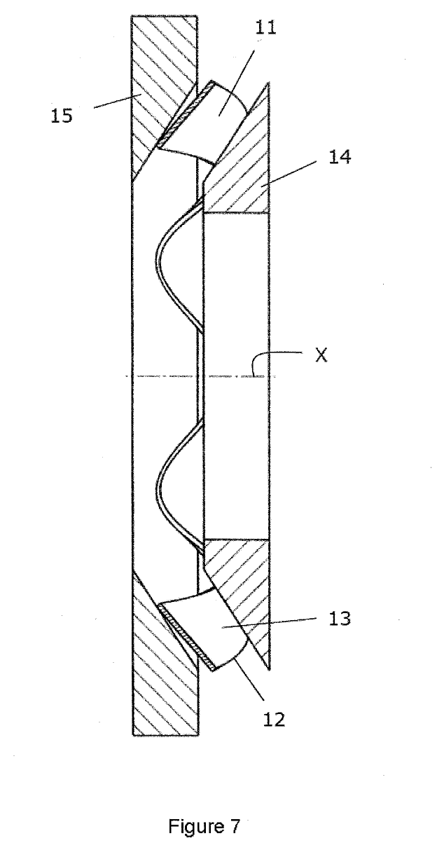

FIG. 7 shows an installation option for the zigzag spring from FIG. 5 in a cross section from the side.

FIG. 1 shows a zigzag spring which is known per se, in a side view at the top and in plan view at the bottom, the following dimensions being defined:

Side view:
b=annular width in the radial direction
t=annular thickness in the axial direction
l₀=spring height in the relieved state
h=undulation height

Plan view:
Dₒ=outer diameter
Dᵢ=inner diameter
Dₘ=middle diameter
b=annular width.

FIG. 2 shows a zigzag spring 1 according to the invention in a side view. An outer circumference 2 of an annular body 3 faces the observer. The annular body is manufactured from a spring steel sheet of thickness t. An undulation structure is stamped in, which undulation structure results in a first spring height l₀1 on the inner circumference which faces away from the observer and a second spring height l₀2 on the visible outer circumference 2. Here, the spring height is the sum of the respective undulation height h and the thickness t. There is therefore a first undulation height h1=l₀1—t which is not denoted in greater detail on the inner diameter and a second undulation height h2=l₀2—t on the outer diameter.

The zigzag spring 1 has a total of six undulations.

FIG. 3 shows the zigzag spring 1 in a cross section from the side, the said zigzag spring 1 being arranged between a first component 4 and a second component 5. Here, the inner side of the zigzag spring 1 with an inner circumference 6 faces the observer. Here, the inner circumference 6 has the greater first spring height l₀1.

The components 4 and 5 can be, for example, an annular collar of a bearing seat and a bearing outer ring of an anti-friction bearing.

The components 4 and 5 are kept at a spacing by way of the zigzag spring, which spacing corresponds to the first spring height l₀1 in the unloaded state. In the case of loading with an axial load, the components 4 and 5 approach one another, the zigzag spring 1 being loaded with an axial force. The geometry and the material properties of the zigzag spring result in a characteristic curve which will be described in the following text using FIG. 4.

Starting from the rest state with a spring travel of zero and a spring force of zero, first of all a linear characteristic curve results up to a spring travel of 0.5 mm and a spring force of approximately 200 N. Subsequently, the spring constant rises greatly and a second linear characteristic curve results up to a spring travel of approximately 0.57 mm and a spring force of approximately 1000 N. The zigzag spring becomes greatly progressive during the further spring travel between 0.57 and 0.6 mm.

The characteristic curve from FIG. 4 is achieved by way of the following parameters:
b=5 mm
t=0.8 mm
l₀1=1.4 mm
l₀2=1.2 mm
Dₒ=90 mm
Dᵢ=80 mm
number of undulations=6
modulus of elasticity=200 000 N/mm².

Finally, FIG. 5 shows a zigzag spring 11 with a conical main body 13 for use in the case of conical seat faces. FIG. 6 shows the said zigzag spring 11 in a cross section from the side.

In the case of this zigzag spring 11, the first spring height on the inner circumference 16 is also greater than the second spring height which is present on the outer circumference 12. The annular body 13 which serves as a base is a part of a cone envelope, configured here with an angle of approximately 45° with respect to the plane. The zigzag spring 11 which results can be inserted, as shown in FIG. 7, between two components 14 and 15 which are supported against one another with substantially compatible surfaces in the shape of cone envelopes. The zigzag spring 11 then provides similar properties to the zigzag spring 1 from FIG. 2. In particular, in the case of otherwise similar parameters, the characteristic curve is also similar to the characteristic curve from FIG. 4. This also results here in a characteristic curve which is first of all linear with a progressive behaviour towards the end of the spring travel.

The above-described zigzag springs 1 and 11 are suitable not only for exclusively axial loading, but rather can also absorb and elastically support tumbling movements or tilting with respect to the x-axis to a limited extent.

1. Axially active zigzag spring (1, 11) having a closed annular body (2, 12) with a central x-axis, the annular body (2, 12) being undulated periodically over the circumference in the direction of the x-axis, characterized in that a spring height is provided in the direction of the x-axis, which spring height is different on the inner circumference (6, 16) of the zigzag spring (1, 11) from on the outer circumference (2, 12) of the zigzag spring.

2. Zigzag spring according to claim 1, characterized in that the spring height on the inner circumference (6, 16) is greater than the spring height on the outer circumference (2, 12).

3. Zigzag spring according to one of the preceding claims, characterized in that the spring height on the outer circumference (2, 12) is from 20% to 80% of the spring height on the inner circumference (6, 16).

4. Zigzag spring according to either of the preceding claims 1 and 2, characterized in that the spring height on the outer circumference (2, 12) is from 10% to 30% of the spring height on the inner circumference (6, 16).

5. Zigzag spring according to either of the preceding claims 1 and 2, characterized in that the spring height on the outer circumference (2, 12) is zero.

6. Zigzag spring according to claim 1, characterized in that the spring height on the inner circumference (6, 16) is from 20% to 80% of the spring height on the outer circumference (2, 12).

7. Zigzag spring according to claim 1, characterized in that the spring height on the inner circumference (6, 16) is smaller than the spring height on the outer circumference (2, 12).

8. Zigzag spring according to claim 1 or 7, characterized in that the spring height on the inner circumference (6, 16) is from 20% to 80% of the spring height on the outer circumference (2, 12).

9. Zigzag spring according to claim 1 or 7, characterized in that the spring height on the inner circumference (6, 16) is from 10% to 30% of the spring height on the outer circumference (2, 12),

10. Zigzag spring according to claim 1 or 7, characterized in that the spring height on the inner circumference (6, 16) is zero.

11. Zigzag spring according to claim 1, characterized in that the spring height on the outer circumference (2, 12) is from 20% to 80% of the spring height on the inner circumference (6, 16).

12. Zigzag spring according to one of the preceding claims, characterized in that the annular body (12) which serves as a base is a part of a cone envelope.

13. Zigzag spring according to one of the preceding claims, characterized in that the zigzag spring has an even number of undulations.

14. Zigzag spring according to one of the preceding claims, characterized in that the zigzag spring has an odd number of undulations.

15. Zigzag spring according to one of the preceding claims, characterized in that the zigzag spring has a number of from four to eight undulations.

16. Use of a zigzag spring according to one of the preceding claims for the axial suspension of an anti-friction bearing of a ball nut in a spindle drive.
